(19) United States
(12) Patent Application Publication
(10) Pub. No.: US 2019/0005067 A1
(43) Pub. Date: Jan. 3, 2019

(54) MULTI-TENANT DATA SERVICE IN DISTRIBUTED FILE SYSTEMS FOR BIG DATA ANALYSIS

(71) Applicant: International Business Machines Corporation, Armonk, NY (US)

(72) Inventors: Xiao Ming Bao, Beijing (CN); Tian Feng, Beijing (CN); Xin Wang, Beijing (CN); Zheng Cai Yuan, Beijing (CN); Yong Zheng, Beijing (CN)

(21) Appl. No.: 15/824,356

(22) Filed: Nov. 28, 2017

Related U.S. Application Data
(63) Continuation of application No. 15/636,770, filed on Jun. 29, 2017.

(51) Int. Cl. G06F 17/30; G06F 9/455; G06F 3/06

(52) U.S. Cl. CPC G06F 17/30235; G06F 2009/45579; G06F 3/067; G06F 9/45558

(57) ABSTRACT

Configuration of a multi-tenant distributed file system on a node. Various tenants and tenant clusters are correlated to a distributed file system, and the distributed file system communicates with various tenants through a connector service. The entire distributed file system exists on a physical node.

### BACKGROUND

The present invention relates generally to the field of storage access and control, and more particularly to memory configuring.

In a converged system, virtualization provides elasticity of computing resources, storage space, and/or application mobility. A converged infrastructure, groups information technology components into a software package. A virtualization container is a software package that includes a file system to install software on a server in a reliable fashion. An example of a virtualization container is Docker. Some virtualization containers include software library frameworks. A software library framework allows for distributed processing of large data sets using a programming model. One example of such a software library framework is Hadoop. A portable operating system interface maintains compatibility between various operating systems. A portable operating system interface defines a set of application programming interfaces. An example of a portable operating system interface standard is POSIX.

Big data analytics allows the analysis of technology in despite the exponential growth and availability of data, including both structured data and unstructured data. Big data analytics, has evolved in two directions: (i) relation database-based massively parallel processing; and (ii) software library framework-based analysis.

### SUMMARY

According to an aspect of the present invention, there is a method, computer program product, and/or system that performs the following operations (not necessarily in the following order): (i) determining a first directory corresponding to a first tenant identifier in a set of tenant identifiers, wherein: (a) the first directory is organized using a first interface standard, and (b) the first tenant identifier corresponds to a first tenant of the first directory; (ii) assigning a connector service to the first directory and the first tenant identifier; (iii) determining a second directory corresponding to the connector service, wherein: (a) the second directory is organized using a second interface standard, (b) a first node contains a first set of files on the second directory, and (c) the first set of files corresponds to the first tenant; (iv) processing a first read/write request in a set of read/write requests using the connector service and the first node, wherein the first read/write request is from the first tenant; and (v) generating a first result to the first read/write request. At least processing the first read/write request using the connector service and the first node is performed by computer software running on computer hardware.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (e.g., software) portion of the first embodiment system;

FIG. 4 is a flowchart showing a second embodiment method performed by a second embodiment of a system according to the present invention;

FIG. 5 is a block diagram view of the second embodiment of the system;

FIG. 6 are lookup tables generated by a third embodiment of the system according to the present invention; and

FIG. 7 is a flowchart showing a third embodiment method performed by a fourth embodiment of a system according to the present invention.

### DETAILED DESCRIPTION

Configuration of a multi-tenant distributed file system on a node. Various tenants and tenant clusters are correlated to a distributed file systems, and the distributed file system communicates with various tenants through a connector service. The entire distributed file system exists on a physical node. This Detailed Description section is divided into the following sub-sections: (i) Hardware and Software Environment; (ii) Example Embodiment; (iii) Further Comments and/or Embodiments; and (iv) Definitions.

### I. Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

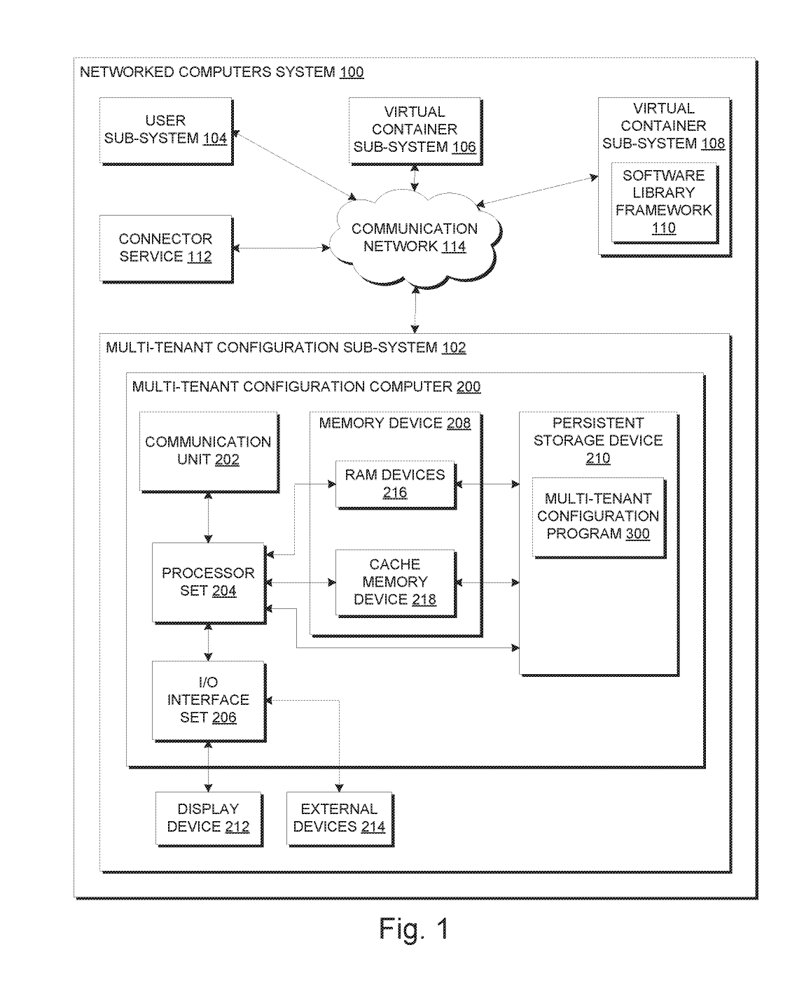

An embodiment of a possible hardware and software environment for software and/or methods according to the present invention will now be described in detail with reference to the Figures. FIG. 1 is a functional block diagram illustrating various portions of networked computers system 100, including: multi-tenant configuration sub-system 102; user sub-system 104; virtual container sub-system 106; virtual container sub-system 108; connector service 112; and communication network 114. Multi-tenant configuration sub-system 102 contains: multi-tenant configuration computer 200; display device 212; and external devices 214. Multi-tenant configuration computer 200 contains: communication unit 202; processor set 204; input/output (I/O) interface set 206; memory device 208; and persistent storage device 210. Memory device 208 contains: random access memory (RAM) devices 216; and cache memory device 218. Persistent storage device 210 contains: multi-tenant configuration program 300. Virtual container sub-system 108 includes: software library framework 110.

Multi-tenant configuration sub-system 102 is, in many respects, representative of the various computer sub-systems in the present invention. Accordingly, several portions of multi-tenant configuration sub-system 102 will now be discussed in the following paragraphs.

Multi-tenant configuration sub-system 102 may be a laptop computer, a tablet computer, a netbook computer, a personal computer (PC), a desktop computer, a personal digital assistant (PDA), a smart phone, or any programmable electronic device capable of communicating with client sub-systems via communication network 114. Multi-tenant configuration program 300 is a collection of machine readable instructions and/or data that is used to create, manage, and control certain software functions that will be discussed in detail, below, in the Example Embodiment sub-section of this Detailed Description section.

Multi-tenant configuration sub-system 102 is capable of communicating with other computer sub-systems via communication network 114. Communication network 114 can be, for example, a local area network (LAN), a wide area network (WAN) such as the Internet, or a combination of the two, and can include wired, wireless, or fiber optic connections. In general, communication network 114 can be any combination of connections and protocols that will support communications between multi-tenant configuration sub-system 102 and client sub-systems.

Multi-tenant configuration sub-system 102 is shown as a block diagram with many double arrows. These double arrows (no separate reference numerals) represent a communications fabric, which provides communications between various components of multi-tenant configuration sub-system 102. This communications fabric can be implemented with any architecture designed for passing data and/or control information between processors (such as microprocessors, communications processors, and/or network processors, etc.), system memory, peripheral devices, and any other hardware components within a system. For example, the communications fabric can be implemented, at least in part, with one or more buses.

Memory device 208 and persistent storage device 210 are computer readable storage media. In general, memory device 208 can include any suitable volatile or non-volatile computer readable storage media. It is further noted that, now and/or in the near future: (i) external devices 214 may be able to supply some, or all, memory for multi-tenant configuration sub-system 102; and/or (ii) devices external to multi-tenant configuration sub-system 102 may be able to provide memory for multi-tenant configuration sub-system 102.

Multi-tenant configuration program 300 is stored in persistent storage device 210 for access and/or execution by one or more processors of processor set 204, usually through memory device 208. Persistent storage device 210: (i) is at least more persistent than a signal in transit; (ii) stores the program (including its soft logic and/or data) on a tangible medium (such as magnetic or optical domains); and (iii) is substantially less persistent than permanent storage. Alternatively, data storage may be more persistent and/or permanent than the type of storage provided by persistent storage device 210.

Multi-tenant configuration program 300 may include both substantive data (that is, the type of data stored in a database) and/or machine readable and performable instructions. In this particular embodiment (i.e., FIG. 1), persistent storage device 210 includes a magnetic hard disk drive. To name some possible variations, persistent storage device 210 may include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage device 210 may also be removable. For example, a removable hard drive may be used for persistent storage device 210. Other examples include optical and magnetic disks, thumb drives, and smart cards that are inserted into a drive for transfer onto another computer readable storage medium that is also part of persistent storage device 210.

Communication unit 202, in these examples, provides for communications with other data processing systems or devices external to multi-tenant configuration sub-system 102. In these examples, communication unit 202 includes one or more network interface cards. Communication unit 202 may provide communications through the use of either or both physical and wireless communications links. Any software modules discussed herein may be downloaded to a persistent storage device (such as persistent storage device 210) through a communications unit (such as communication unit 202).

I/O interface set 206 allows for input and output of data with other devices that may be connected locally in data communication with multi-tenant configuration computer 200. For example, I/O interface set 206 provides a connection to external devices 214. External devices 214 will typically include devices, such as a keyboard, a keypad, a touch screen, and/or some other suitable input device. External devices 214 can also include portable computer readable storage media, such as, for example, thumb drives, portable optical or magnetic disks, and memory cards. Software and data used to practice embodiments of the present invention (e.g., multi-tenant configuration program 300) can be stored on such portable computer readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

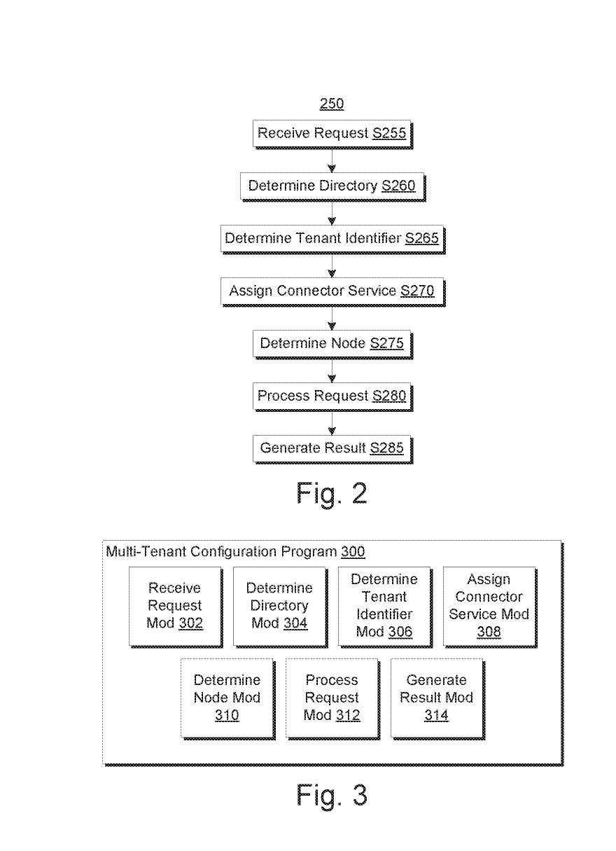

FIG. 2 shows flowchart 250 depicting a method according to the present invention.

FIG. 3 shows multi-tenant configuration program 300, which performs at least some of the method operations of flowchart 250. This method and associated software will now be discussed, over the course of the following paragraphs, with extensive reference to FIG. 2 (for the method operation blocks) and FIG. 3 (for the software blocks).

Processing begins at operation S255, where receive request module (“mod”) 302 receives a set of requests. In some embodiments of the present invention, receive request mod 302 receives a set of requests from a set of requestors. Examples of a requestor include, but are not limited to, a software library framework, a virtual container, and/or a user. In some embodiments, a set of requests are a set of input/output (“I/O”) requests. In further embodiments, a set of requests are a set of read/write requests. In some of these embodiments, a set of requests are a set of I/O read/write requests. An example of a virtual container is Docker. An example of a software library framework is Hadoop. In further embodiments, receive request mod 302 receives a set of requests from a set of dynamic instantiations of a requestor.

In some embodiments, a requestor is a first distributed file system. In some of these embodiments, a first distributed file system is not POSIX compatible. In further embodiments, a first distributed file system is organized using a first interface standard. In some embodiments, a set of requests relates to a second distributed file system. In some of these embodiments, a second distributed file system is POSIX compatible. In further embodiments, a second distributed file system is organized using a second interface standard. Alternatively, in some embodiments: (i) a first distributed file system is POSIX compatible; and (ii) a second distributed file system is not POSIX compatible. In further alternative embodiments, neither a first distributed file system, nor a second distributed file system, are POSIX compatible, but the first distributed file system and the second distributed file system are organized using different interface standards.

Processing proceeds to operation S260, where determine directory mod 304 determines a set of directories corresponding to a set of requestors. In some embodiments of the present invention, determine directory mod 304 determines a set of directories corresponding to a set of requestors. A directory is a structure for organization of a set of computer files. A directory is sometimes also called a path, a folder, and/or a drawer. A directory can be expressed in various forms, including: (i) parent_folder/child_folder/file.extension; and/or (ii) Parent Folder>Child Folder>File. In some of these embodiments, determine directory mod 304 determines a set of directories corresponding to a set of tenant identifiers. In other embodiments, determine directory mod 304 determines a set of directories corresponding to a set of tenant identifiers by assigning a directory to a set of requestors. In further embodiments, determine directory mod 304 determines a set of directories corresponding to a set of tenant identifiers by assigning a subdirectory to a set of requestors. In some embodiments, a first requestor in a set of requestors corresponds to a first directory. In other embodiments, a set of requestors share a first directory. In some embodiments, determine directory mod 304 determines a set of directories corresponding to a set of requestors from which receive request mod 302 received a set of requests in operation S255.

Processing proceeds to operation S265, where determine tenant identifier mod 306 determines a set of tenant identifiers corresponding to a set of requests. In some embodiments of the present invention, determine tenant identifier mod 306 determines a set of tenant identifiers corresponding to a set of requests. In some embodiments, determine tenant identifier mod 306 determines a set of tenant identifiers for a set of requestors that are dynamic instantiations. In alternative embodiments, determine tenant identifier mod 306 determines a set of tenant identifiers for a set of virtual containers. In further embodiments, determine tenant identifier mod 306 determines a set of tenant identifiers for a set of software library frameworks. Alternatively, determine tenant identifier mod 306 determines a set of tenant identifiers for a set of users. In some embodiments, determine tenant identifier mod 306 determines a set of tenant identifiers for a set of instances of a set of tenants. In some embodiments, determine tenant identifier mod 306 determines a set of tenant identifiers corresponding to a set of requests received by receive request mod 302 in operation S255. Alternatively, determine tenant identifier mod 306 determines a set of tenant identifiers corresponding to a set of directories determined by determine directory mod 304 in operation S260.

Processing proceeds to operation S270, where assign connector service mod 308 assigns a connector service. In some embodiments of the present invention, assign connector service mod 308 assigns a connector service. In further embodiments, a connector service is an only connector service on a computer system. Alternatively, a connector service is an only connector service associated with a first distributed file system and a second distributed file system. In some of these embodiments, a connector service directs requests from a set of requestors on a first distributed file system directed to a second distributed file system. In other embodiments, assign connector service mod 308 assigns a connector service based, at least in part, on a set of tenant identifiers. In further embodiments, assign connector service mod 308 assigns a connector service based, at least in part, on a set of directories. A connector service is sometimes also called a connection server. A connector service directs a set of requests through a set of appropriate channels. A connection server may also perform functions including, but not limited to: (i) authenticate a set of users; (ii) entitle a set of users to a set of resources; (iii) assign a set of packages to a set of resources; (iv) manage local and/or remote sessions; (v) establish a set of secure connections; and/or (vi) apply policies. In some embodiments, assign connector service mod 308 assigns a connector service based, at least in part, on a set of requestors of a set of requests received by receive request mod 302 in operation S255. In other embodiments, assign connector service mod 308 assigns a connector service based, at least in part, on a set of requests received by receive request mod 302 in operation S255. In further embodiments, assign connector service mod 308 assigns a connector service based, at least in part, on a set of directories determined by determine directory mod 304 in operation S260. In alternative embodiments, assign connector service mod 308 assigns a connector service based, at least in part, on a set of tenant identifiers determined by determine tenant identifier mod 306 in operation S265.

Processing proceeds to operation S275, where determine node mod 310 determines a node corresponding to a set of requestors. In some embodiments of the present invention, determine node mod 310 determines a node corresponding to a set of requestors. In some of these embodiments, determine node mod 310 determines that a first node corresponds to each requestor in a set of requestors. In some of these embodiments, determine node mod 310 determines that a physical node corresponds to a set of requestors. In other embodiments, determine node mod 310 determines that a virtual node corresponds to a set of requestors. In alternative embodiments, determine node mod 310 determines a node corresponding to a set of requestors by assigning each requestor in the set of requestors to a first node. In some embodiments, determine node mod 310 determines a node corresponding to a set of requests. In further embodiments, determine node mod 310 determines a node corresponding to a set of tenant identifiers. In other embodiments, determine node mod 310 determines a node based, at least in part, on a connector service. In alternative embodiments, determine nod mod 310 determines a node based, at least in part, on a one-to-one relationship between the node and a connector service. In other embodiments, determine node 310 maps a path between a connector service and a node. In some embodiments, determine node mod 310 determines a node corresponding to a set of requestors from which receive request mod 302 received a set of requests in operation S255. In other embodiments, determine node mod 310 determines a node corresponding to a set of requests received by receive request mod 302 in operation S255. In further embodiments, determine node mod 310 determines a node corresponding to a set of directories determined by determine directory mod 304 in operation S260. In alternative embodiments, determine node mod 310 determines a node corresponding to a set of tenant identifiers determined by determine tenant identifier mod 306 in operation S265. Alternatively, determine node mod 310 determines a node based, at least on part, on a connector service assigned by assign connector service mod 308 in operation S270.

Processing proceeds to operation S280, where process request mod 312 processes a set of requests. In some embodiments of the present invention, process request mod 312 processes a set of requests. In some embodiments, process request mod 312 processes a set of requests based, at least in part, on a set of tenant identifiers. In other embodiments, process request mod 312 processes a set of requests based, at least in part, on a node. In further embodiments, process request mod 312 processes a set of requests based, at least in part, on a directory. In some embodiments, process request mod 312 mounts a first distributed file system to a second distributed file system. In alternative embodiments, process request mod 312 processes a set of requests based, at least in part, on a connector service. For a read request, process request mod 312 reads a set of data from a storage. For a write request, process request mod 312 modifies a set of data in a storage. For an input request, process request mod 312 receives a set of data. For an output request, process request mod 312 transmits a set of data. In some embodiments, process request mod 312 processes a set of requests received by receive request mod 312 in operation S255. In other embodiments, process request mod 312 processes a set of requests based, at least in part, on a set of tenant identifiers determined by determine tenant identifier mod 306 in operation S265. In further embodiments, process request mod 312 processes a set of requests based, at least in part, on a node determined by determine node mod 310 in operation S275. In other embodiments, process request mod 312 processes a set of requests based, at least in part, on a set of directories determined by determine directory mod 304 in operation S260. In alternative embodiments, process request mod 312 processes a set of requests based, at least in part, on a connector service determined by determine connector service mod 308 in operation S270.

Processing terminates at operation S285, where generate result mod 314 generates a set of results. In some embodiments of the present invention, generate result mod 314 generates a set of results for a set of requests. In some embodiments, generate result mod 314 generates a set of results to a set of read requests by generating a set of messages including a set of data. In some embodiments, generate result mod 314 generates a set of results to a set of write requests by generating a set of new data entries. In some embodiments, generate result mod 314 generates a set of results to a set of input requests by storing a set of data that was received. In some embodiments, generate result mod 314 generates a set of results to a set of output requests by generating a set of messages. In other embodiments, generate result mod 314 generates results for a first distributed file system that is not POSIX compatible. In further embodiments, generate result mod 314 generates a set of results for a first distributed file system that is Hadoop. In other embodiments, a result includes, but is not limited to, a new data entry and/or a message with a set of data. In some embodiments, generate result mod 314 generates a set of results to a set of requests received by receive request mod 302 in operation S255.

### III. Further Comments and/or Embodiments

Some embodiments of the present invention recognize the following facts, potential problems, and/or potential areas for improvement with respect to the current state of the art: (i) managing a set of nodes, a set of connector services, and/or a set of directories corresponding to a set of tenant identifiers leads to an exponential increase in resources; (ii) various operating systems handle a set of nodes, a set of connector services, and/or a set of directories in a multitude of fashions; and/or (iii) some distributed file systems (“DFSs”) are not portable operating system interface (“POSIX”) compatible; (iv) some DFSs cannot be mounted; and/or (v) hyper-convergence infrastructures attempt to decrease resource usage. Under conventional means of managing a set of nodes, a set of connector services, and/or a set of directories corresponding to a set of tenant identifiers requires individual nodes and individual directories corresponding to each tenant identifier.

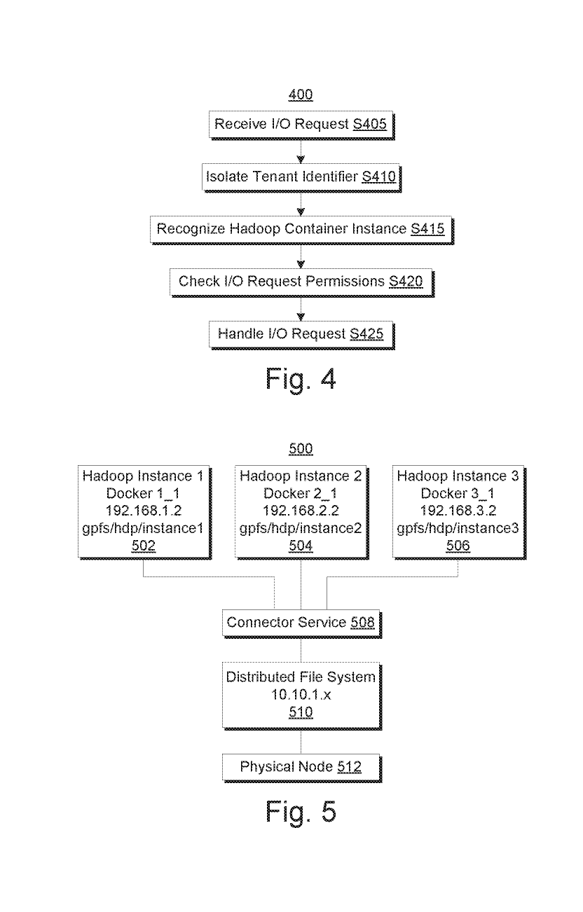

FIG. 4 shows flowchart 400 depicting a method according to the present invention. Processing begins at operation S405, where a multi-tenant configuration sub-system receives an I/O request from a Hadoop container instance. Processing proceeds to operation S410, where a multi-tenant configuration sub-system isolates a set of tenant identifiers for a Hadoop container instance. Processing proceeds to operation S415, where a multi-tenant configuration sub-system recognizes a Hadoop container instance based, at least in part, on a set of tenant identifiers. Processing proceeds to operation S420, where a multi-tenant configuration sub-system checks a set of permissions for a Hadoop container instance. Processing terminates at operation S425, where a multi-tenant configuration sub-system handles an I/O request.

FIG. 5 shows a functional block diagram of system 500, including: Hadoop instance 502; Hadoop instance 504; Hadoop instance 506; connector service 508; distributed file system 510; and physical node 512. Communication between each of Hadoop instance 502, Hadoop instance 504, and Hadoop instance 506 and distributed file system 510 traverses through connector service 508. By existing on physical node 512, distributed file system 510 can process all communications through connector service 508.

Some embodiments of the present invention may include one, or more, of the following features, characteristics, and/or advantages: (i) isolating a set of DFS instance data; (ii) isolating a set of Hadoop instance data; (iii) introducing a multi-tenant recognition module in a DFS connector service; and/or (iv) providing a multi-tenant capability for a hyper-converged DFS. A hyper-converged DFS is sometimes also referred to as a multi-tenant DFS. In some embodiments of the present invention, a multi-tenant recognition module incorporates operation S410 and operation S415 of FIG. 4. In other embodiments, connector service 508 in FIG. 5 performs operation S410 and/or operation S415 of FIG. 4. In further embodiments, multi-tenant configuration sub-system provides a connector service and a physical node in a one-to-one relationship. In alternative embodiments, multi-tenant configuration sub-system configures a set of DFS instances with a set of private network addresses. Alternatively, a multi-tenant configuration sub-system configures a set of DFS instances with a private network address. In some embodiments, a multi-tenant configuration sub-system isolates a DFS instance in a directory. In further embodiments, a multi-tenant configuration sub-system isolates a DFS instance in a directory based, at least in part, on a tenant. In other embodiments, a multi-tenant configuration sub-system isolates a set of operations for a DFS instance in a directory.

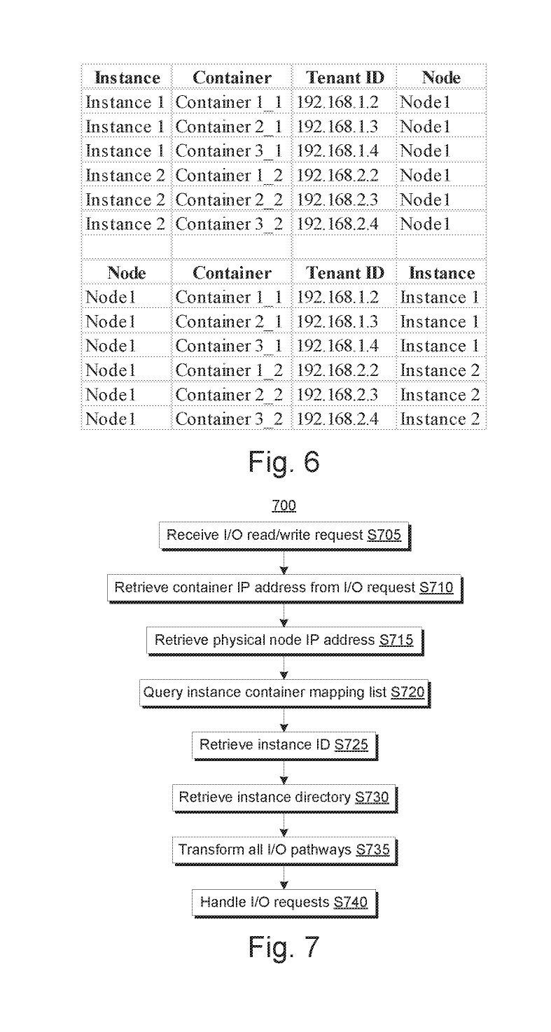

FIG. 6 shows two tables. The first table in FIG. 6 is an instance container mapping list. Two instances with three containers are shown, resulting in six tenant IDs. These six tenant IDs are all mapped to one node. The second table in FIG. 6 is a reverse instance container mapping list. The same six tenant IDs are shown. However, the second table is sorted to determine a corresponding instance.

FIG. 7 shows flowchart 700 depicting a method according to the present invention. Processing begins at operation S705, where a multi-tenant configuration sub-system receives an I/O read/write request from a Hadoop job in a container. Processing proceeds to operation S710, where a multi-tenant configuration sub-system retrieves a container IP address from an I/O request. Processing proceeds to operation S715, where a multi-tenant configuration sub-system retrieves a physical node IP address. Processing proceeds to operation S720, where a multi-tenant configuration sub-system queries an instance container mapping list based on a container IP and a node IP. Processing proceeds to operation S725, where a multi-tenant configuration sub-system retrieves an instance ID. Processing proceeds to operation S730, where a multi-tenant configuration sub-system retrieves an instance directory. Processing proceeds to operation S735, where a multi-tenant configuration sub-system transforms a set of I/O pathways. Processing terminates at operation S740, where a multi-tenant configuration sub-system handles a set of I/O requests.

Some embodiments of the present invention may include one, or more, of the following features, characteristics, and/or advantages: (i) a DFS allows access to a set of files from a variety of hosts; (ii) a DFS allows a set of users to share a set of files across a set of devices; and/or (iii) a DFS is a popular storage system. Examples of DFSs include: IBM General Parallel File System (“GPFS”) File Placement Optimizer (“FPO”), Red Hat Linux, GlusterFS, Lustre, Ceph, and Apache Hadoop Distributed File System (“HDFS”).

Some embodiments of the present invention may include one, or more, of the following features, characteristics, and/or advantages: (i) mounting a DFS; (ii) reading data from a DFS; (iii) writing data to a DFS; (iv) reading data from a DFS using a POSIX application; (v) writing data to a DFS using a POSIX application; (vi) reading data from a DFS using a POSIX application in the DFS ecosystem; and/or (vii) writing data to a DFS using a POSIX application in the DFS ecosystem. Some embodiments of the present invention may include one, or more, of the following features, characteristics, and/or advantages: (i) determining a set of permissions based, at least in part, on a user ID; (ii) determining a set of permissions based, at least in part, on a group ID; (iii) determining a set of permissions for an operating environment; and/or (iv) determining a set of permissions for an operating system.

Some embodiments of the present invention may include one, or more, of the following features, characteristics, and/or advantages: (i) running a DFS using a POSIX application; (ii) transferring a set of files over a single connector service; (iii) transferring a set of files over a single connector service on a DFS using a POSIX application; and/or (iv) running a hyper-converged DFS using a POSIX application. Some embodiments of the present invention may include one, or more, of the following features, characteristics, and/or advantages: (i) running a DFS using a non-POSIX application; (ii) transferring a set of files over a single connector service; (iii) transferring a set of files over a single connector service on a DFS using a non-POSIX application; and/or (iv) running a hyper-converged DFS using a non-POSIX application. Some embodiments of the present invention may include one, or more, of the following features, characteristics, and/or advantages: (i) creating a set of clusters of a set of DFS instances; (ii) creating a set of clusters of a set of DFS instances for a set of users; (iii) assigning a set of network addresses to a set of clusters; (iv) assigning a set of tenant identifiers to a set of clusters; (v) assigning a set of network addresses to a set of clusters, wherein the set of network addresses are not related to a DFS; and/or (vi) assigning a set of tenant identifiers to a set of clusters, wherein the set of network addresses are not related to a DFS.

Some embodiments of the present invention may include one, or more, of the following features, characteristics, and/or advantages: (i) reducing a number of connector services; (ii) using a single connector service; (iii) reducing a number of connector services required to maintain a multi-tenant configuration; (iv) reducing a number of connector services required to maintain a multi-tenant configuration at an exponential level; (v) reducing a number of tenant identifiers corresponding to a number of clients on a DFS; and/or (vi) reducing a number of IP addresses corresponding to a number of clients on a DFS.

In some embodiments of the present invention, a multi-tenant configuration sub-system generates a DFS cluster for a tenant. In further embodiments, a multi-tenant configuration sub-system generates a tenant ID corresponding to a DFS cluster. A DFS cluster is sometimes also referred to as a first distributed file system with multiple requestors and/or multiple tenants. In some of these embodiments, a multi-tenant configuration sub-system assigns a tenant ID to a node.

Some embodiments of the present invention may include one, or more, of the following features, characteristics, and/or advantages: (i) configure a set of directories in a DFS; (ii) configure a set of directories in a DFS and restart a connector service; (iii) creating a set of software library framework instances for a DFS instance; (iv) storing a set of tenant information in a directory in a hyper-converged DFS; (v) recognizing a DFS a directory without restarting; (vi) restarting a DFS without creating a new DFS instance; (vii) providing a DFS cluster for a tenant; (viii) maintaining a DFS cluster for a tenant; and/or (ix) isolating a DFS based, at least in part, on a set of hardware resources. Some embodiments of the present invention may include one, or more, of the following features, characteristics, and/or advantages: (i) generating a user ID when building a software library framework; (ii) generating a user ID when compiling a software library framework; (iii) generating a group ID when building a software library framework; and/or (iv) generating a group ID when compiling a software library framework.

Some embodiments of the present invention may include one, or more, of the following features, characteristics, and/or advantages: (i) managing a hyper-converged big-data DFS; (ii) managing a multi-tenant big-data DFS; (iii) managing a hyper-converged DFS in a cloud system; and/or (iv) managing a hyper-converged DFS in a virtual system.

### IV. Definitions

“Present invention” does not create an absolute indication and/or implication that the described subject matter is covered by the initial set of claims, as filed, by any as-amended set of claims drafted during prosecution, and/or by the final set of claims allowed through patent prosecution and included in the issued patent. The term “present invention” is used to assist in indicating a portion or multiple portions of the disclosure that might possibly include an advancement or multiple advancements over the state of the art. This understanding of the term “present invention” and the indications and/or implications thereof are tentative and provisional and are subject to change during the course of patent prosecution as relevant information is developed and as the claims may be amended.

“Embodiment,” see the definition for “present invention.”

“And/or” is the inclusive disjunction, also known as the logical disjunction and commonly known as the “inclusive or.” For example, the phrase “A, B, and/or C,” means that at least one of A or B or C is true; and “A, B, and/or C” is only false if each of A and B and C is false.

A “set of” items means there exists one or more items; there must exist at least one item, but there can also be two, three, or more items. A “subset of” items means there exists one or more items within a grouping of items that contain a common characteristic.

A “plurality of” items means there exists at more than one item; there must exist at least two items, but there can also be three, four, or more items.

“Includes” and any variants (e.g., including, include, etc.) means, unless explicitly noted otherwise, “includes, but is not necessarily limited to.”

A “user” or a “subscriber” includes, but is not necessarily limited to: (i) a single individual human; (ii) an artificial intelligence entity with sufficient intelligence to act in the place of a single individual human or more than one human; (iii) a business entity for which actions are being taken by a single individual human or more than one human; and/or (iv) a combination of any one or more related “users” or “subscribers” acting as a single “user” or “subscriber.”

The terms “receive,” “provide,” “send,” “input,” “output,” and “report” should not be taken to indicate or imply, unless otherwise explicitly specified: (i) any particular degree of directness with respect to the relationship between an object and a subject; and/or (ii) a presence or absence of a set of intermediate components, intermediate actions, and/or things interposed between an object and a subject.

A “module” is any set of hardware, firmware, and/or software that operatively works to do a function, without regard to whether the module is: (i) in a single local proximity; (ii) distributed over a wide area; (iii) in a single proximity within a larger piece of software code; (iv) located within a single piece of software code; (v) located in a single storage device, memory, or medium; (vi) mechanically connected; (vii) electrically connected; and/or (viii) connected in data communication. A “sub-module” is a “module” within a “module.”

A “computer” is any device with significant data processing and/or machine readable instruction reading capabilities including, but not necessarily limited to: desktop computers; mainframe computers; laptop computers; field-programmable gate array (FPGA) based devices; smart phones; personal digital assistants (PDAs); body-mounted or inserted computers; embedded device style computers; and/or application-specific integrated circuit (ASIC) based devices.

“Electrically connected” means either indirectly electrically connected such that intervening elements are present or directly electrically connected. An “electrical connection” may include, but need not be limited to, elements such as capacitors, inductors, transformers, vacuum tubes, and the like.

“Mechanically connected” means either indirect mechanical connections made through intermediate components or direct mechanical connections. “Mechanically connected” includes rigid mechanical connections as well as mechanical connection that allows for relative motion between the mechanically connected components. “Mechanically connected” includes, but is not limited to: welded connections; solder connections; connections by fasteners (e.g., nails, bolts, screws, nuts, hook-and-loop fasteners, knots, rivets, quick-release connections, latches, and/or magnetic connections); force fit connections; friction fit connections; connections secured by engagement caused by gravitational forces; pivoting or rotatable connections; and/or slidable mechanical connections.

A “data communication” includes, but is not necessarily limited to, any sort of data communication scheme now known or to be developed in the future. “Data communications” include, but are not necessarily limited to: wireless communication; wired communication; and/or communication routes that have wireless and wired portions. A “data communication” is not necessarily limited to: (i) direct data communication; (ii) indirect data communication; and/or (iii) data communication where the format, packetization status, medium, encryption status, and/or protocol remains constant over the entire course of the data communication.

The phrase “without substantial human intervention” means a process that occurs automatically (often by operation of machine logic, such as software) with little or no human input. Some examples that involve “no substantial human intervention” include: (i) a computer is performing complex processing and a human switches the computer to an alternative power supply due to an outage of grid power so that processing continues uninterrupted; (ii) a computer is about to perform resource intensive processing and a human confirms that the resource-intensive processing should indeed be undertaken (in this case, the process of confirmation, considered in isolation, is with substantial human intervention, but the resource intensive processing does not include any substantial human intervention, notwithstanding the simple yes-no style confirmation required to be made by a human); and (iii) using machine logic, a computer has made a weighty decision (for example, a decision to ground all airplanes in anticipation of bad weather), but, before implementing the weighty decision the computer must obtain simple yes-no style confirmation from a human source.

“Automatically” means “without any human intervention.”

The term “real time” (and the adjective “real-time”) includes any time frame of sufficiently short duration as to provide reasonable response time for information processing as described. Additionally, the term “real time” (and the adjective “real-time”) includes what is commonly termed “near real time,” generally any time frame of sufficiently short duration as to provide reasonable response time for on-demand information processing as described (e.g., within a portion of a second or within a few seconds). These terms, while difficult to precisely define, are well understood by those skilled in the art.

What is claimed is:

1. A method comprising:
determining a first directory corresponding to a first tenant identifier in a set of tenant identifiers, wherein:
the first directory is organized using a first interface standard, and
the first tenant identifier corresponds to a first tenant of the first directory;
assigning a connector service to the first directory and the first tenant identifier;
determining a second directory corresponding to the connector service, wherein:
the second directory is organized using a second interface standard,
a first node contains a first set of files on the second directory, and
the first set of files corresponds to the first tenant;
processing a first read/write request in a set of read/write requests using the connector service and the first node, wherein the first read/write request is from the first tenant; and
generating a first result to the first read/write request;
wherein:
at least processing the first read/write request using the connector service and the first node is performed by computer software running on computer hardware.

2. The method of claim 1, further comprising:
determining a third directory corresponding to a second tenant identifier in the set of tenant identifiers, wherein:
the second tenant identifier corresponds to a second read/write request in the set of read/write requests, and
the third directory is organized using the first interface standard;
assigning the connector service to the third directory and the second tenant identifier;
processing the second read/write request using the connector service and a second node, wherein:
a second node contains a second set of files on the second directory, and
the second set of files corresponds to the second tenant; and
generating a second result to the second read/write request.

3. The method of claim 2, wherein the second node is the first node.

4. The method of claim 1, wherein the first result is selected from a group consisting of:
a new data entry, and
a message with a set of data.

5. The method of claim 1, wherein the first interface standard is not POSIX compatible.

6. The method of claim 1, wherein the second interface standard is POSIX compatible.

7. The method of claim 1, wherein the first directory is organized using an Apache Hadoop Distributed File System (“HDFS”).
